(19) United States
(12) Patent Application Publication
(10) Pub. No.: US 2025/0224007 A1
(43) Pub. Date: Jul. 10, 2025

(54) OPPOSED PISTON TYPE MONOBLOCK BRAKE CALIPER AND METHOD FOR MANUFACTURING OPPOSED PISTON TYPE MONOBLOCK BRAKE CALIPER

(71) Applicant: NISSAN MOTOR CO., LTD., Yokohama-shi, Kanagawa (JP)

(72) Inventors: Yuki MATSUURA, Kanagawa (JP); Shinichi KOBAYASHI, Kanagawa (JP); Tetsuo KIMURA, Kanagawa (JP)

(73) Assignee: NISSAN MOTOR CO., LTD., Yokohama-shi, Kanagawa (JP)

(21) Appl. No.: 18/879,604

(22) PCT Filed: Jun. 29, 2022
(86) PCT No.: PCT/JP2022/025877

§ 371 Date: Dec. 27, 2024

(51) Int. Cl. F16D 55/226; B33Y 80/00; F16D 55/00; F16D 65/00; F16D 121/04; F16D 125/06

(52) U.S. Cl. CPC F16D 55/226; B33Y 80/00; F16D 65/0068; F16D 2055/0016; F16D 2121/04; F16D 2125/06; F16D 2200/0004; F16D 2250/00

(57) ABSTRACT

An opposed piston type monoblock brake caliper is monolithically formed of metal. The brake caliper includes a first body provided on one side of a disc accommodation space and a second body provided on the other side of the disc accommodation space. The brake caliper also includes a first bridge section and a second bridge section, each of which connects the first body and the second body. A brake fluid path is formed in the first body, the second body and the first bridge section to connect a first cylinder in the first body and a second cylinder in the second body. A bleeder path to which a bleeder bolt is attached is formed inside the first bridge section. The bleeder path is connected to a small cross-sectional-area section of the brake fluid path inside the first bridge section.

### TECHNICAL FIELD

The present invention relates to an opposed piston type monoblock brake caliper and a method for manufacturing an opposed piston type monoblock brake caliper.

### BACKGROUND ART

Patent Literatures 1 and 2 listed below are Japanese patent application publications by an identical applicant and each of them discloses an opposed piston type monoblock brake caliper that is formed monolithically. The monoblock brake caliper has high rigidity and can achieve high braking performance by reducing its deformation during braking. The brake caliper disclosed in the Patent Literature 1 is manufactured by casting. Drawings in the Patent Literature 1 do not show a brake fluid path (although it is explained in a paragraph [0022] of the Patent Literature 1). However, according to disclosures of the Patent Literature 2, two brake fluid paths are formed inside the caliper (see [FIG. 3] and paragraphs [0012]-[0013] of the Patent Literature 2).

The caliper has two sets of opposed pistons. One of its two brake fluid paths connects two cylinders for the pistons on one side and is extended diagonally to the other side on its opposite side to open at the other side. The other of the two brake fluid paths connects two piston cylinders on the other side and is extended diagonally to the one side on its opposite side to open at the one side. The one path and the other path are substantially symmetrical with respect to the center plane of a brake disc, and their diagonal portions intersect with each other within the caliper. A brake piping from a brake master cylinder is connected to an open end of the one path, and a bleeder bolt is attached to an open end of the other path.

### CITATION LIST

### Patent Literature

Patent Literature 1: Japanese Patent Application Publication No. 2021-63528

Patent Literature 2: Japanese Patent Application Publication No. H10-30660

### SUMMARY OF INVENTION

### Problem to be Solved

If air is entrapped inside the brake fluid paths in the brake caliper, a fluid pressure being transmitted by a brake fluid is not properly transmitted to the pistons. Therefore, when newly filling or replacing the brake fluid, air in the brake fluid paths is discharged as much as possible using the bleeder bolt. It is also necessary to prevent air from entering the brake fluid paths not only when newly filling or replacing the brake fluid. In other words, when designing the brake fluid paths, it is necessary to consider the prevention of air entrapment in the brake fluid paths.

An object of the present invention is to provide an opposed piston type monoblock brake caliper that can effectively restrict air entrapment in its brake fluid path. Another object of the present invention is to provide a method for manufacturing a brake caliper that can effectively restrict air entrapment in its brake fluid path.

### Solution to Problem

A first aspect of the present invention provides an opposed piston type monoblock brake caliper monolithically formed with metal. The brake caliper includes a first body provided on one side of a disc accommodation space that accommodates a brake disc and a second body provided on another side of the disc accommodation space. The brake caliper also includes a first bridge section that connects the first body and the second body at one end of the disc accommodation space and a second bridge section that connects the first body and the second body at another end of the disc accommodation space. A brake fluid path is formed in the first body, the second body and the first bridge section to connect a first cylinder in the first body and a second cylinder in the second body. A bleeder path, one end of which is connected with the brake fluid path and to another end of which a bleeder bolt is attached, is formed inside the first bridge section. The bleeder path is connected to the brake fluid path inside the first bridge section. A small cross-sectional-area section, a cross-sectional area of which is smaller than a cross-sectional area of other sections of the brake fluid path, is formed on the brake fluid path inside the first bridge section. The small cross-sectional-area section is communicated with the bleeder path.

A second aspect of the present invention provides a method for manufacturing an opposed piston type monoblock brake caliper. The brake caliper manufactured by the method includes a first body provided on one side of a disc accommodation space that accommodates a brake disc and a second body provided on another side of the disc accommodation space. The brake caliper also includes a first bridge section that connects the first body and the second body at one end of the disc accommodation space and a second bridge section that connects the first body and the second body at another end of the disc accommodation space. The brake caliper is monolithically formed with metal by three dimensional printing while forming a brake fluid path inside the first body, the second body and the first bridge section to connect a first cylinder in the first body and a second cylinder in the second body.

### Advantageous Effects

According to the aspects, it is possible to restrict air entrapment in its brake fluid path.

### BRIEF DESCRIPTION OF DRAWINGS

FIG. 1 is a perspective view of an opposed piston type monoblock brake caliper according to a first embodiment.

FIG. 2 is a rear view of the brake caliper.

FIG. 3 is a cross-sectional view taken along a line III-III shown in FIG. 2.

FIG. 4 is an enlarged cross-sectional view of a portion IV shown in FIG. 3.

FIG. 5 is a perspective view of an opposed piston type monoblock brake caliper according to a second embodiment.

FIG. 6 is a cross-sectional view (a cross-sectional view taken along a line VI-VI shown in FIG. 2) of an opposed piston type monoblock brake caliper according to a third embodiment.

FIG. 7 is a cross-sectional view of an opposed piston type monoblock brake caliper according to a fourth embodiment.

FIG. 8 is a rear view of the brake caliper.

### DESCRIPTION OF EMBODIMENTS

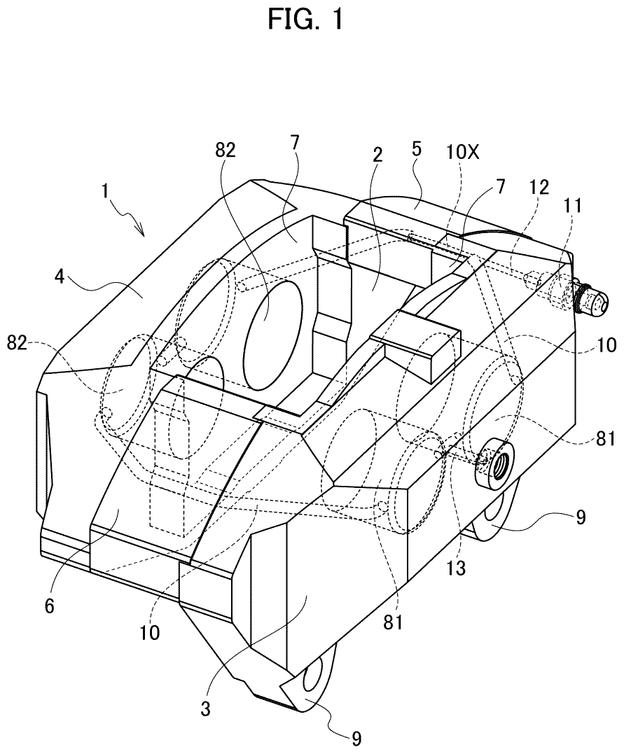

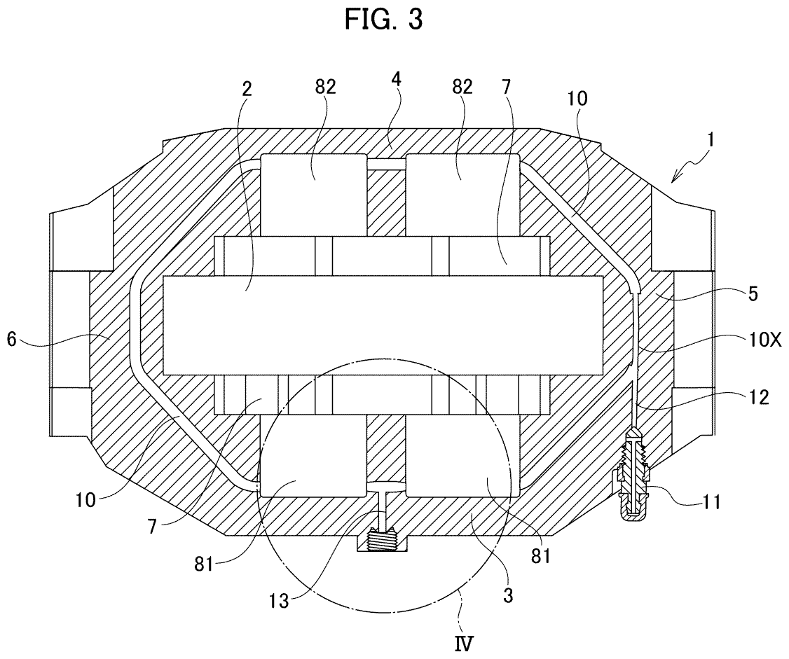

Hereinafter, opposed piston type monoblock brake calipers according to embodiments and a method for manufacturing them will be described with reference to the drawings. First, a brake caliper according to a first embodiment is described with reference to FIG. 1 through FIG. 4.

The brake caliper 1 according to the first embodiment is a so-called “monoblock” brake caliper that is monolithically made with metal. Although a monoblock caliper made with metal can be manufactured by casting or cutting, the brake caliper 1 according to the present embodiment is manufactured by three-dimensional printing (hereinafter simply referred to as “3D printing”). The manufacturing method of the brake caliper 1 by 3D printing will be described later.

The brake caliper 1 is an “opposed piston type” brake caliper in which two pairs of opposed pistons are installed. FIG. 1 through FIG. 4 show the brake caliper 1 with no pistons installed. However, a bleeder bolt 11 described later is installed in the brake caliper 1 shown in FIG. 1 through FIG. 4. A brake disc that is interposed between the opposing pistons is also not shown in the drawings. Note that the brake caliper 1 shown in FIG. 1 through FIG. 4 is a brake caliper for a front wheel of a four-wheeled vehicle.

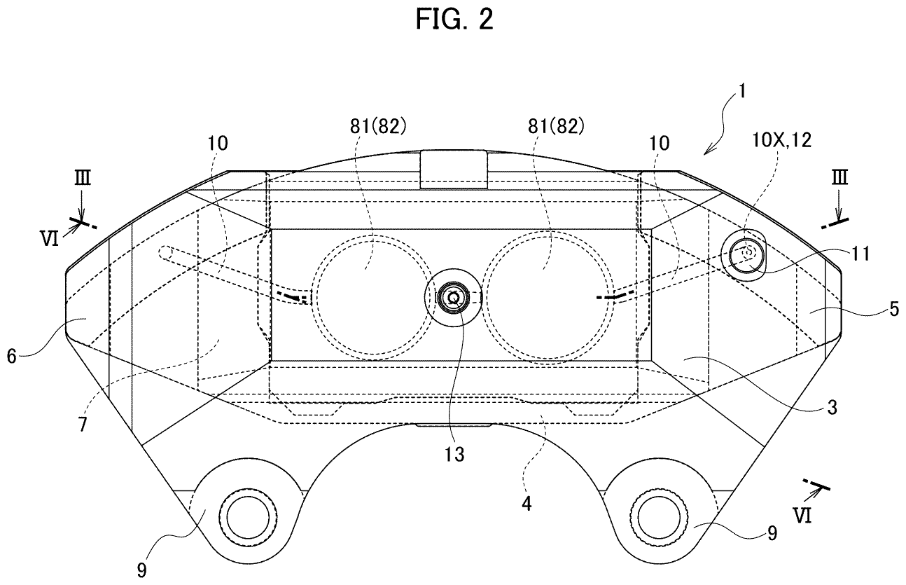

The brake caliper 1 includes a first body 3 provided on one side (right side in FIG. 1) and a second body 4 provided on the other side (left side in FIG. 1) such that a disc accommodation space 2 for accommodating the brake disc is interposed therebetween. And, the brake caliper 1 also includes a first bridge section 5 provided at one end (right end in FIG. 2) of the disc accommodation space 2 and a second bridge section 6 provided at the other end (left end side in FIG. 2). Since the brake caliper 1 is a monoblock brake caliper as described above, the first body 3, the second body 4, the first bridge section 5, and the second bridge section 6 are monolithically formed.

When the brake caliper 1 is installed on the vehicle, the first body 3 is positioned on an inner side of the vehicle and the second body 4 is positioned on the outer side. The above-mentioned disc accommodation space 2 is formed between the first body 3 and the second body 4. A brake pad accommodation recess 7 is formed on an inner surface of the first body 3 facing the disc accommodation space 2. On an inner side face of the brake pad accommodation recess 7, two first cylinders 81, that house two first pistons (not shown) respectively, are formed so as to be aligned in a circumferential direction of the brake disc.

A pair of brackets 9 for fixing the brake caliper 1 to a suspension component such as a hub carrier are also monolithically formed on a lower section of the first body 3 in FIG. 1 and FIG. 2. Symmetrically to the first body 3, a brake pad accommodation recess 7 is formed on an inner surface of the second body 4 facing the disc accommodation space 2. On an inner side face of the brake pad accommodation recess 7, two cylindrical second cylinders 82, that house two second pistons (not shown) respectively, are formed so as to be aligned in the circumferential direction of the brake disc. The second pistons in the second cylinders 82 are made opposite to the first pistons in the first cylinders 81.

The first bridge section 5 connects the first body 3 and the second body 4 so as to get across the disc accommodation space 2. The second bridge section 6 similarly connects the first body 3 and the second body 4 so as to get across the disc accommodation space 2. In FIG. 1 and FIG. 2, the disc accommodation space 2 and the brake pad accommodation recesses 7 are made open upwardly. Components (not shown) for retaining the brake pads are installed at this open portion.

The brake caliper 1 also includes a brake fluid path 10 formed inside the first body 3, the second body 4 and the first bridge section 5 to connect the first cylinders 81 and the second cylinders 82. The brake fluid path 10 also connects the two first cylinders 81 to each other. The brake fluid path 10 also connects the two second cylinders 82. Looking at this section alone, the brake fluid path 10 is U-shaped. However, in the present embodiment, the brake fluid path 10 is formed also inside the second bridge section 6 to connect the first cylinders 81 and the second cylinders 82, so that it forms a loop path as a whole.

A bleeder path 12 is also formed inside the first bridge section 5, its one end is connected to the brake fluid path 10 and the bleeder bolt 11 is attached to its other end. Thus, the bleeder path 12 is connected to the brake fluid path 10 inside the first bridge section 5. A brake fluid discharge path is also formed inside the bleeder bolt 11, and this discharge path can be made communicated with the bleeder path 12 by loosening the bleeder bolt 11. When the bleeder bolt 11 is tightened, the bleeder path 12 is closed. When the brake fluid is newly filled or replaced, the bleeder bolt 11 is used to discharge air from the brake fluid path 10 through the bleeder path 12. Note that the bleeder bolt 11 in the drawings has a rubber cap for preventing contamination by foreign matters such as sand and water and an O-ring for preventing brake fluid leakage.

The brake fluid path 10 in the first bridge section 5 has a small cross-sectional-area section 10X whose cross-sectional area is made smaller than a cross-sectional area of other sections of the brake fluid path 10 (excluding orifices 14 described later). In other words, the inner diameter of the small cross-sectional-area section 10X is smaller than the inner diameters of the other sections of the brake fluid path 10. The bleeder path 12 is directly connected to this small cross-sectional-area section 10X. The cross-sectional area of the bleeder path 12 is also the same as the cross-sectional area of the small cross-sectional-area section 10X. More specifically, the small cross-sectional-area section 10X and the bleeder path 12 are arranged in a straight line, and a path with the small cross-sectional area is formed in a straight line from the small cross-sectional-area section 10X to the bleeder path 12. Advantages brought by providing the small cross-sectional-area section 10X will be described later.

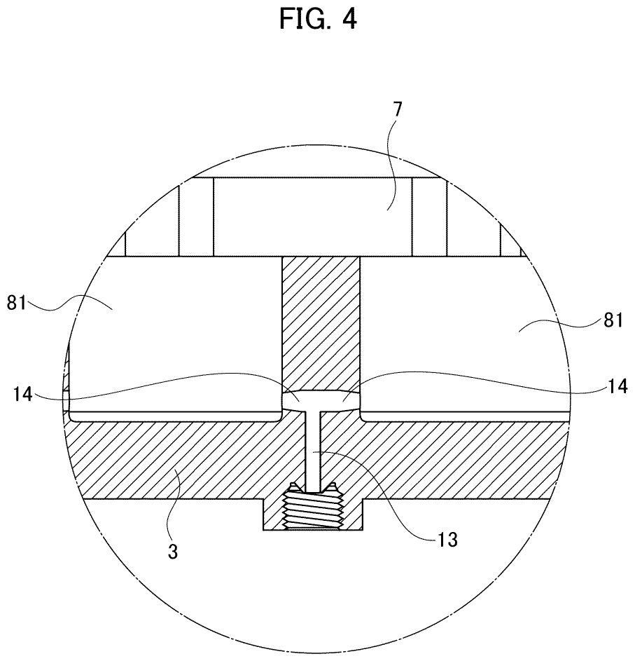

A fluid inlet path 13 that is connected to a brake piping from a brake master cylinder is also formed inside the first body 3. As shown in FIG. 4, one end of the fluid inlet path 13 is connected to the brake fluid path 10 between the two first cylinders 81. And, in the present embodiment, an orifice 14 with a locally narrowed inner diameter is formed on the brake fluid path 10 between each of the two first cylinders 81 and the other end (opening end) of the fluid inlet path 13. More particularly, on the section between the two first cylinders 81 of the brake fluid path 10, the orifice 14 is formed just before one of the first cylinders 81 and the other orifice 14 is also formed just before the other of the first cylinders 81.

The cross-sectional area of the brake fluid path 10 is locally narrowed at the orifices 14. Each of the orifices 14 acts as a flow resistance for the fluid and can slightly delay a pressure rise in the brake fluid in the brake caliper 1. Advantages brought by forming the orifices 14 will be described later. Note that one orifice 14 may be provided on the fluid inlet path 13. Also in this case, the orifice 14 is also formed between each of the two first cylinders 81 and the other end (opening end) of the fluid inlet path 13.

According to the brake caliper 1 monolithically formed of the first body 3, the second body 4, the first bridge section 5 and the second bridge section 6 in the present embodiment, the brake fluid path 10 is formed inside the first body 3, the second body 4 and the first bridge section 5. The bleeder path 12 is also formed inside the first bridge section 5, and its one end is connected to the brake fluid path 10 and the bleeder bolt 11 is attached to its other end. The bleeder path 12 is connected to the brake fluid path 10 inside the first bridge section 5. The small cross-sectional-area section 10X whose cross-sectional area is made smaller than the cross-sectional areas of the other sections of the brake fluid path 10 is formed on the brake fluid path 10 inside the first bridge section 5. The small cross-sectional-area section 10X is communicated with the bleeder path 12.

The bleeder path 12, to which the bleeder bolt 11 is attached, is connected to the highest point of the brake fluid path 10 when the brake caliper 1 is installed on the vehicle because of its function of purging air from the brake fluid path 10. When purging air from the brake fluid path 10, the air stays in the small cross-sectional-area section 10X and the bleeder path 12 at the highest position. This air is purged through the small cross-sectional-area section 10X and the bleeder path 12 that have a small cross-sectional area by the brake fluid supplied from the large cross-sectional-area sections of the brake fluid path 10 to the small cross-sectional-area section 10X. Since the cross-sectional area at the termination of the purging path is made small, the air is less remained in the small cross-sectional-area section 10X and the bleeder path 12. In addition, the flow velocity of the brake fluid increases in the small cross-sectional-area section 10X and the bleeder path 12 that have a small cross-sectional area, and thereby the air is surely purged with the brake fluid. As a result, air entrapment in the brake fluid path 10, including the small cross-sectional-area section 10X, can be effectively prevented.

Particularly in the present embodiment, the small cross-sectional-area section 10X and the bleeder path 12 are formed in a straight line in the present embodiment, and thereby purging of air and purging of the brake fluid with air mixed therein can be done smoothly.

According to the brake caliper 1 in the present embodiment, the brake fluid path 10 is also formed inside the second bridge section 6 to form a loop path. Therefore, there are no dead end in the brake fluid path 10, and air in the brake fluid path 10 can be purged reliably through the one bleeder path 12. In other words, since the brake fluid path 10 forms a loop path, air can be purged surely through the bleeder path 12 by flowing the brake fluid from both of the brake fluid path 10 in the first body 3 and the brake fluid path 10 in the second body 4 to the bleeder path 12. In addition, the cross-sectional area of the small cross-sectional-area section 10X is small, i.e., its inner diameter is small, so the flow resistance of the fluid in the small cross-sectional-area section 10X is increased. However, the fluid pressure can be reliably transmitted to the second cylinder 82 without delay by the brake fluid path 10 in the second bridge section 6.

Note that, in a monoblock brake caliper, it is also possible to provide a pipe outside the brake caliper instead of the brake fluid path 10 inside the first bridge section 5 (or the second bridge section 6) shown in the present embodiment. However, if such a pipe is used, flare bolts for fastening the pipe are also required, and thus the number of parts increases. In addition, a process for installing the pipe is also required, and management of its fastener. There is also possibility of pipe breakage due to contact with a road wheel while replacing the road wheel. If the fasteners of the pipe loosen, there is concern about air infiltration or contamination by foreign matters through the fasteners. When an entire of the brake fluid path 10 is formed inside the brake caliper 1 like as in the present embodiment, all those concerns can be eliminated.

According to the brake caliper 1 in the present embodiment, the one end of the fluid inlet path 13 is connected to the brake fluid path 10 and its other end is connected to the brake piping. Then, the orifices 14 are formed on the sections of the brake fluid path 10 that directly connects the one end of the fluid inlet path 13 to the two first cylinders 81, respectively. Therefore, the pressure rise of the brake fluid in the brake caliper 1 can be delayed. As described above, is the brake caliper 1 of the present embodiment having the orifices 14 is used for the front wheels and a brake caliper without orifice is used for the rear wheels, the fluid pressure of the rear wheels rises slightly earlier than that of the front wheels upon braking. Therefore, the deterioration of the straight-running stability of the vehicle can be prevented upon braking and thus the vehicle stability can be improved. In addition, the vehicle's nose dive can be also prevented by raising the fluid pressure of the rear wheels earlier than that of the front wheels.

Since the orifices 14 are provided in order to delay the pressure rise of the brake fluid in the brake caliper 1 in which the orifices 14 are formed, the above advantage can be brought similarly even if one orifice 14 is formed on the fluid inlet path 13. The position of the orifice 14 may vary depending on the connecting position of the one end of the fluid inlet path 13 with the brake fluid path 10. For example, in a case where the one end of the fluid inlet path 13 is connected to the brake fluid path 10 between the first cylinder 81 and the second cylinder 82, the one end of the fluid inlet path 13 is directly connected to both the first cylinder 81 and the second cylinder 82. In such a case, an orifice 14 is provided on a section of the brake fluid path 10 that directly connects the one end of the fluid inlet path 13 to the first cylinder 81. At the same time, an orifice 14 is also provided on a section of the brake fluid path 10 that directly connects the one end of the fluid inlet path 13 to the second cylinder 82.

That is, it is sufficient that the orifice 14 is formed on the fluid inlet path 13, or on the section of the brake fluid path 10 that directly connects the one end of the fluid inlet path 13 to the first cylinder 81 and/or the second cylinder 82. In the present embodiment, the one end of fluid inlet path 13 is directly connected to the two first cylinders 81, but is not directly connected to the second cylinders 82.

Next, a method for manufacturing the brake caliper 1 according to the present embodiment will be described. In the present embodiment, the brake caliper 1 is manufactured by a powder bed method. The metal powder is fused into solid metal (or sintered) by irradiating a laser beam or an electron beam onto a metal powder bed. Especially when a laser beam is used, it is called the SLM (Selective Laser Melting) method or SLS (Selective Laser Sintering) method. In the present embodiment, the brake caliper 1 is printed in layers from a lower portion of its posture shown in FIG. 2. However, a cutting process for flattening seating faces of the bracket 9 and a minimum machining process for forming fastening threads of the bleeder bolt 11 and fastening threads of the brake piping at the open end of the fluid inlet path 13 are done after the 3D printing.

Since the powder bed method provides high modeling accuracy, the curved brake fluid path 10 can be suitably formed inside the brake caliper 1. It is particularly suitable for forming the small cross-sectional-area section 10X and the bleeder path 12 that have a small cross-sectional area.

During the 3D printing, the first body 3 (including the brackets 9 and so on), the second body 4, the first bridge section 5, and the second bridge section 6 are formed monolithically. In parallel with the monolithically forming, the brake fluid path 10 (including the small cross-sectional-area section 10X and the orifices 14), the bleeder path 12, and the fluid inlet path 13 are also formed inside them simultaneously. Since these paths are 3D printed, flexibility for routing them is high. The brake fluid path 10 (the small cross-sectional-area section 10X) inside the first bridge section 5 and the second bridge section 6, which runs over the brake disc, should be made distanced from the brake disc as possible even inside the brake caliper 1, because the brake disc becomes high temperature due to friction heat. Such routing can be formed with ease by 3D printing, and thereby the temperature rise of the brake fluid in the brake fluid path 10 can be prevented.

In the present embodiment, the powder bed method was used as the 3D printing method. However, other 3D printing methods such as a metal deposition method may be used. In such cases, the brake fluid path 10 can be suitably formed inside the brake caliper 1. In particular, 3D printing is suitable for forming the small cross-sectional-area section 10X and the bleeder path 12 that have a small cross-sectional area.

According to the manufacturing method in the present embodiment, the first body 3, the second body 4, the first bridge section 5, and the second bridge section 6 are monolithically formed with metal by 3D printing. While forming these sections, the brake fluid path 10 connecting the first cylinders 81 and the second cylinders 82 is also formed inside the brake caliper 1. As described above, if an external pipe is used to form the brake fluid path, there is concern about air infiltration through fasters for the pipe. However, in the present embodiment, since the brake fluid path 10 is formed inside the brake caliper 1, air entrapment in the brake fluid path 10 can be effectively prevented.

In addition, flexibility for routing the brake fluid path 10 by 3D printing is high as described above, and it is easy to form the brake fluid path 10 in a curved shape. For example, when manufacturing a monoblock brake by casting, cores for forming the brake fluid path 10 becomes very thin. Therefore, there is concern that a constriction may be formed on the brake fluid path 10. In addition, it is also difficult to remove the cores from the brake fluid path 10 after casting. Since forming flexibility of the cores is not high, the flexibility for routing the brake fluid path 10 becomes low.

When manufacturing a monoblock brake by casting or cutting, its brake fluid paths may be formed by drilling. Also in the cases of the above mentioned Patent Literatures 1 and 2, their intersecting paths seem to be formed by drilling. However, the brake fluid paths formed by drilling must become straight, and thus the routing flexibility of the brake fluid paths is low. In addition, it is also required to plug unnecessary sections on the paths formed by drilling. This also raises concerns about air filtration and contamination by foreign matters through the plugged sections. According to the manufacturing method of the present embodiment, those concerns are eliminated.

According to the manufacturing method in the present embodiment, when the brake fluid path 10 is formed, its small cross-sectional-area section 10X and the bleeder path 12 are also formed. Since the small cross-sectional-area section 10X and the bleeder path 12 have the smaller cross-sectional area as described above, casting using cores or machined using a thin drill is difficult. That is, 3D printing can suitably form the small cross-sectional-area section 10X and the bleeder path 12. In addition, the above-described advantages brought by the small cross-sectional-area section 10X and the bleeder path 12 can be also brought by the brake caliper 1 manufactured by the manufacturing method in the present embodiment.

According to the manufacturing method in the present embodiment, it is also easy to form the brake fluid path 10 as the loop path by also forming it inside the second bridge section 6. The above-described advantages due to the brake fluid path 10 as the loop path can be also brought by the brake caliper 1 manufactured by the manufacturing method in the present embodiment.

Furthermore, according to the manufacturing method in the present embodiment, it is also easy to form the orifices 14 on the fluid inlet path 13 or on the section of the brake fluid path 10 that directly connects the one end of the fluid inlet path 13 with the first cylinder 81 and/or the second cylinder 82. The above-described advantages brought by the orifices 14 can be also brought by the brake caliper 1 manufactured by the manufacturing method in the present embodiment.

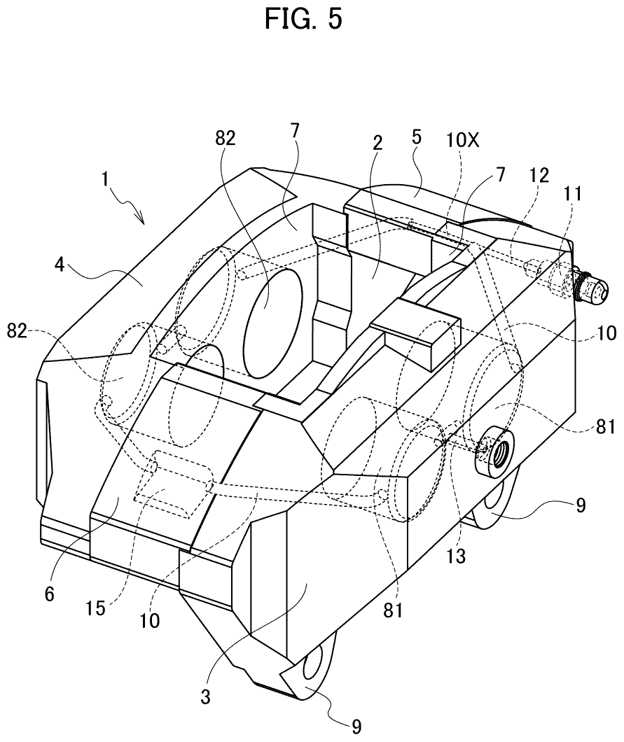

A brake caliper 1 according to a second embodiment is shown in FIG. 5. The difference between the brake caliper 1 in the present embodiment and the brake caliper 1 in the above-described first embodiment is that a chamber 15 for storing brake fluid is formed on the brake fluid path 10 formed inside the second bridge section 6. Since the configurations other than the chamber 15 are the same as those in the first embodiment, their redundant explanations are omitted.

The chamber 15 can hold a sufficient amount of the brake fluid in its inside. Note that the bleeder path 12 is located at the highest position when the brake caliper 1 is installed on the vehicle, as described above. The brake fluid path 10 is connected to the highest point of the chamber 15 when the brake caliper 1 is installed on the vehicle. The chamber 15 increases the amount of the brake fluid inside the brake caliper 1.

During braking, the brake pads are pressed against the brake disc by the pistons housed in the first cylinders 81 and the second cylinders 82. At this time, the face runout of the brake disc may cause pulsations in the brake fluid pressure in the brake caliper 1. Such pulsations can be suppressed by increasing the amount of brake fluid, and thereby fluctuations of the fluid pressure and fluctuations of wheel torque can be reduced and judder vibration can be suppressed.

Note that the chamber 15 is provided on the brake fluid path 10 inside the second bridge section 6 in the present embodiment, but it may be provided anywhere on the brake fluid path 10 other than the small cross-sectional-area section 10X. However, the capacity of the chamber 15 can be increased by providing the chamber 15 inside the second bridge section 6, and thereby the above-described pulsation damping effect can be effectively brought. In addition, the chamber 15 is located between the first body 3 and the second body 4 when the chamber 15 is provided inside the second bridge section 6, and thereby the above-mentioned pulsations that occur in the first cylinders 81 and the second cylinders 82 can be effectively damped.

The brake caliper 1 is manufactured by 3D printing also in the present embodiment similarly to the first embodiment. The chamber 15 is also formed while the brake fluid path 10 is formed. It is impossible to form the chamber 15, of which internal space is expanded, on the brake fluid path 10 by drilling. Although it is not impossible with casting using cores, casting using cores has the above-described concerns. In other words, 3D printing can suitably form the chamber 15 on the brake fluid path 10. In addition, the above-described advantages brought by the chamber 15 can be also brought by the brake caliper 1 manufactured by the manufacturing method in the present embodiment.

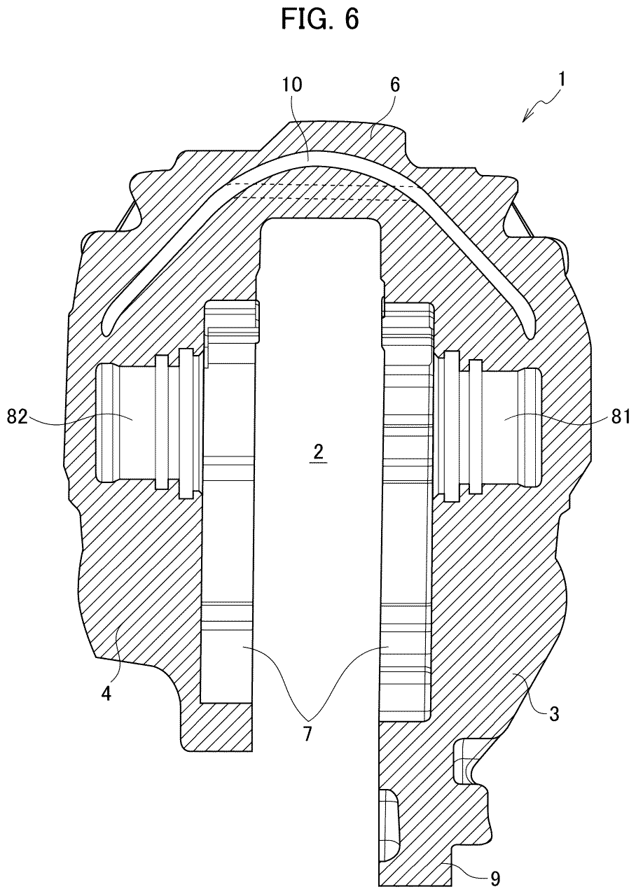

A cross-sectional view of a brake caliper 1 according to a third embodiment is shown in FIG. 6. This cross-sectional view is taken along a line VI-VI shown in FIG. 2 (although the brake caliper 1 shown in FIG. 2 is the first embodiment). In the first embodiment, the brake fluid path 10 inside the second bridge section 6 is formed straight, as shown by dotted lines in FIG. 6. In the present embodiment, the brake fluid path 10 inside the second bridge section 6 is curved to be distanced from the brake disc, i.e., from the disc accommodation space 2.

In other words, the brake fluid path 10 formed inside the second bridge section 6 is made convexly curved outward in the radial direction of the brake disc (the disc accommodation space 2). Therefore, the brake fluid path 10 inside the second bridge section 6 is located closer to the outer circumference of the brake caliper 1 than to the inner circumference of the disc accommodation space 2. The brake disc in the disc accommodation space 2 heats up due to frictional heat during braking. The brake fluid in the brake fluid path 10 can be distanced radially away from the brake disc, which is the heat source, by forming the brake fluid path 10 in such a curved shape, and thereby heat transfer to the brake fluid can be suppressed. Vapor lock can be avoided by suppressing the heat transfer to the brake fluid.

In the present embodiment, the brake fluid path 10 in the second bridge section 6 is curved as described above. The brake fluid path 10 within the first bridge section 5, i.e., the small cross-sectional-area section 10X of the brake fluid path 10, may be curved in the same manner. In this case, the heat transfer to the brake fluid in the brake fluid path 10 (the small cross-sectional-area section 10X) can also be suppressed. However, when the small cross-sectional-area section 10X is curved, the bleeder path 12 is connected to the apex of the curvature.

The brake caliper 1 is manufactured by 3D printing also in the present embodiment similarly to the first embodiment. The brake fluid path 10 is radially outwardly convex and curved as described above during its formation. It is impossible to form the curved brake fluid path 10 by drilling. Although it is not impossible with casting using cores, casting using cores has the above-described concerns. In other words, 3D printing can suitably form the above-described curved brake fluid path 10. In addition, the above-described advantages brought by the above-described curved brake fluid path 10 can be also brought by the brake caliper 1 manufactured by the manufacturing method in the present embodiment.

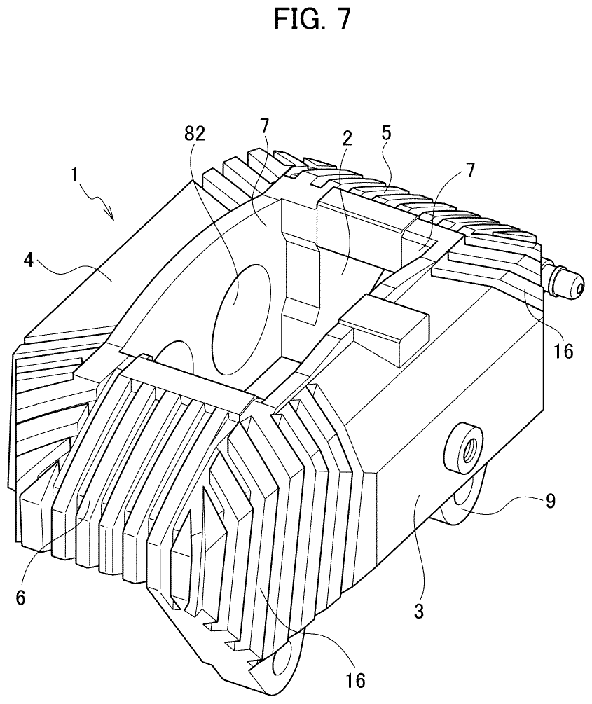

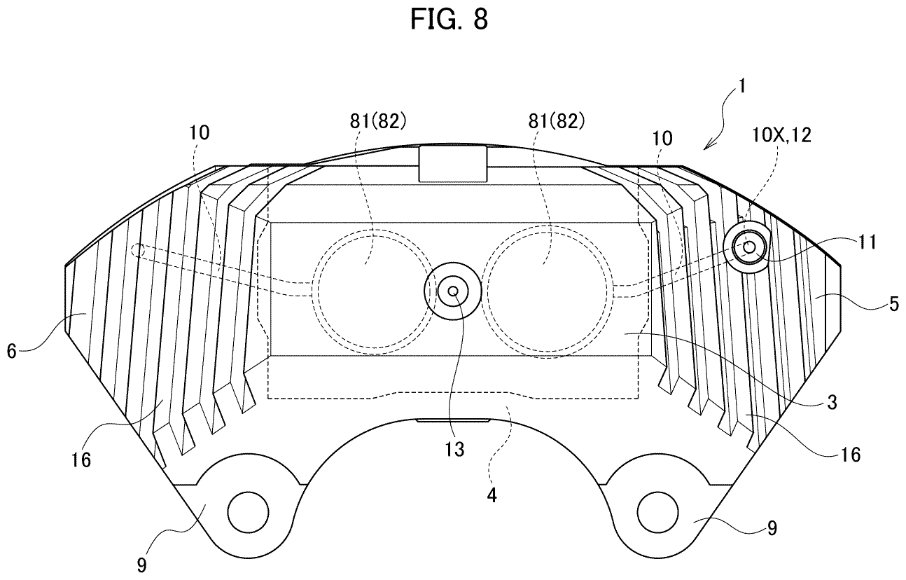

A perspective view and a rear view of a brake caliper 1 according to a fourth embodiment are shown in FIG. 7 and FIG. 8, respectively. In the present embodiment, plural heat radiation fins 16 are formed on the outer surface of the first bridge section 5 along the brake fluid path 10 (the small cross-sectional-area section 10X) formed inside the first bridge section 5. Plural heat radiation fins 16 are also formed on the outer surface of the second bridge section 6 along the brake fluid path 10 formed inside the second bridge section 6. Since the configurations other than the heat radiation fins 16 are the same as those in the first embodiment, their redundant explanations are omitted.

In the present embodiment, the heat radiation fins 16 are formed extensively and are formed on almost the entire outer surface of the first bridge section 5 and the second bridge section 6. In addition, in the present embodiment, the heat radiation fins 16 are more extensively formed and are also formed on a portion of the outer surface of the first body 3 and a portion of the outer surface of the second body 4.

Since the brake disc becomes hot due to frictional heat as described above, the brake fluid in the brake fluid path 10 (the small cross-sectional-area section 10X) inside the first bridge section 5 and the second bridge section 6, which runs over the brake disc, is susceptible to heat. Therefore, the heat radiation can be promoted at the first bridge section 5 and the second bridge section 6 by forming the heat radiation fins 16 to increase the surface area, as in the present embodiment. As a result, the temperature rise of the brake fluid in the brake fluid path 10 can be prevented.

In the present embodiment, the heat radiation fins 16 are formed on the outer surfaces of the first bridge section 5 and the second bridge section 6. However, the heat radiation fins 16 may be formed only on the outer surface of the first bridge section 5. Alternatively, the heat radiation fins 16 may be formed only on the outer surface of the second bridge section 6. The heat radiation fins 16 may be formed at least along the brake fluid path 10 formed inside the first bridge section 5 (or the second bridge section 6), and may be formed more extensively as in the present embodiment.

The brake caliper 1 is manufactured by 3D printing also in the present embodiment similarly to the first embodiment. The heat radiation fins 16 are formed monolithically at the same time when the brake caliper 1 is printed. It is not impossible to form plural heat radiation fins 16 by cutting afterwards, but the cutting process is additionally required. It is relatively easy to form the plural heat radiation fins 16 having complex shapes by 3D printing. Since it is difficult to fill the molten metal surely into narrow spaces, it is difficult to form these heat radiation fins 16. The above-described advantages brought by the above-described heat radiation fins 16 can be also brought by the brake caliper 1 manufactured by the manufacturing method in the present embodiment.

### REFERENCE SIGNS LIST

1 brake caliper
2 disc accommodation space
3 first body
4 second body
5 first bridge section
6 second bridge section
81 first cylinder
82 second cylinder
10 brake fluid path
10X small cross-sectional-area section
11 bleeder bolt
12 bleeder path
13 fluid inlet path
14 orifice
15 chamber
16 heat radiation fin

1.-13. (canceled)

14. An opposed piston type monoblock brake caliper monolithically formed with metal, the brake caliper comprising:
a first body that is provided on one side of a disc accommodation space that accommodates a brake disc and in which a first cylinder that houses a first piston is formed;
a second body that is provided on another side of the disc accommodation space and in which a second cylinder houses a second piston, which is opposed to the first piston, is formed;
a first bridge section that is provided at one end of the disc accommodation space and connects the first body and the second body with the disc accommodation space interposed therebetween;
a second bridge section that is provided at another end of the disc accommodation space and connects the first body and the second body with the disc accommodation space interposed therebetween;
a brake fluid path that is formed in the first body, the second body and the first bridge section to connect the first cylinder and the second cylinder; and
a bleeder path that is formed inside the first bridge portion, one end of the bleeder path being connected with the brake fluid path and a bleeder bolt being attached to another end of the bleeder path,
wherein the bleeder path is connected to the brake fluid path inside the first bridge section,
wherein a small cross-sectional-area section is formed on the brake fluid path inside the first bridge section and is communicated with the bleeder path, a cross-sectional area of the small cross-sectional-area section being smaller than a cross-sectional area of other sections of the brake fluid path, and
wherein the brake fluid path formed inside the first bridge section is convexly curved outward in a radial direction of the brake disc with the disc accommodation space interposed between the first body and the second body.

15. The opposed piston type monoblock brake caliper according to claim 14,
wherein the brake fluid path is also formed inside the second bridge section to form a loop path.

16. The opposed piston type monoblock brake caliper according to claim 15,
wherein the brake fluid path formed inside the second bridge section is convexly curved outward in a radial direction of the brake disc with the disc accommodation space interposed between the first body and the second body.

17. The opposed piston type monoblock brake caliper according to claim 15,
wherein a plurality of heat radiation fins are formed on an outer surface of the first bridge section or the second bridge section along the brake fluid path formed inside the first bridge section or the second bridge section.

18. The opposed piston type monoblock brake caliper according to claim 14,
wherein a chamber that stores brake fluid is formed on the brake fluid path other than the small cross-sectional-area section.

19. The opposed piston type monoblock brake caliper according to claim 14, further comprising
a fluid inlet path whose one end is connected to the brake fluid path and whose another end is connected with a brake piping,
wherein an orifice is formed on the fluid inlet path or on a section of the brake fluid path that directly connects the one end of the fluid inlet path to the first cylinder and/or the second cylinder.

20. A method for manufacturing an opposed piston type monoblock brake caliper, wherein the brake caliper comprises:
a first body that is provided on one side of a disc accommodation space that accommodates a brake disc and in which a first cylinder that houses a first piston is formed;
a second body that is provided on another side of the disc accommodation space and in which a second cylinder houses a second piston, which is opposed to the first piston, is formed;
a first bridge section that is provided at one end of the disc accommodation space and connects the first body and the second body with the disc accommodation space interposed therebetween;
a second bridge section that is provided at another end of the disc accommodation space and connects the first body and the second body with the disc accommodation space interposed therebetween;
the method comprising:
monolithically forming the brake caliper with metal by three dimensional printing while forming a brake fluid path inside the first body, the second body and the first bridge section to connect the first cylinder and the second cylinder,
wherein the brake fluid path formed inside the first bridge section is convexly curved outward in a radial direction of the brake disc with the disc accommodation space interposed between the first body and the second body.

21. The method for manufacturing an opposed piston type monoblock brake caliper, according to claim 20,
wherein the brake caliper is monolithically formed by three-dimensional printing while forming a bleeder path inside the first bridge portion, one end of the bleeder path being connected with the brake fluid path and a bleeder bolt being attached to another end of the bleeder path, and
wherein a small cross-sectional-area section is formed on the brake fluid path inside the first bridge section and is communicated with the bleeder path, a cross-sectional area of the small cross-sectional-area section being smaller than a cross-sectional area of other sections of the brake fluid path.

22. The method for manufacturing an opposed piston type monoblock brake caliper, according to claim 21,
wherein the brake caliper is monolithically formed by three-dimensional printing while forming the brake fluid path also inside the second bridge section so that the brake fluid path forms a loop path.

23. The method for manufacturing an opposed piston type monoblock brake caliper, according to claim 22,
wherein the brake fluid path formed inside the second bridge section is convexly curved outward in a radial direction of the brake disc with the disc accommodation space interposed between the first body and the second body.

24. The method for manufacturing an opposed piston type monoblock brake caliper, according to claim 22,
wherein a plurality of heat radiation fins are formed by three-dimensional printing on an outer surface of the first bridge section or the second bridge section along the brake fluid path formed inside the first bridge section or the second bridge section.

25. The method for manufacturing an opposed piston type monoblock brake caliper, according to claim 21,
wherein a chamber that stores brake fluid is formed on the brake fluid path other than the small cross-sectional-area section.

26. The method for manufacturing an opposed piston type monoblock brake caliper, according to claim 20,
wherein a fluid inlet path is formed while the brake fluid path is formed, one end of the fluid inlet path being connected to the brake fluid path and another end of the fluid inlet path being connected with a brake piping, and
wherein an orifice is formed on the fluid inlet path or on a section of the brake fluid path that directly connects the one end of the fluid inlet path to the first cylinder and/or the second cylinder.
